(19) United States
(12) Patent Application Publication
(10) Pub. No.: US 2006/0019748 A1
(43) Pub. Date: Jan. 26, 2006

(54) Communication unit and sales management method of a gaming machine using the communication unit

(75) Inventor: Yoko Aikawa, Koto-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Tokyo (JP)

(21) Appl. No.: 11/183,984

(22) Filed: Jul. 19, 2005

(30) Foreign Application Priority Data
Jul. 21, 2004 (JP) 2004-213391
Jul. 21, 2004 (JP) 2004-213392

(51) Int. Cl. A63F 13/00

(52) U.S. Cl. 463/40

(57) ABSTRACT

In a store where a plurality of gaming machines which are manufactured by different game makers are installed, the present invention provides a communication unit which can construct a system which allows the store to grasp a sales amount in real time and, at the same time, can allow the store side to arbitrarily select the construction or the non-construction of the system depending on the size of the store or the like. The communication system can also reduce a constructing cost and a running cost of the system. In the communication unit which is connectable to the gaming machines and a server which manages a store in which the gaming machines are installed through a communication line, when coins which are inserted in the gaming machine are detected by the gaming machine or value information is read from a prepaid card, the sales information are cumulatively added and are stored upon receiving signals outputted from the gaming machine, and the stored sales information are transmitted to the server.

### CROSS-REFERENCES TO THE RELATED APPLICATIONS

This application is based upon and claims the priorities from a prior Japanese patent application No. 213391, filed on Jul. 21, 2004, in Japan and a prior Japanese patent application No. 213392, filed on Jul. 21, 2004, in Japan, entire contents of which are incorporated herein by reference.

### BACKGROUND OF THE INVENTION

1. Field of the Invention

The present invention relates to a communication unit which allows the connection between a gaming machine and a server which manages a store in which the gaming machine is installed through a communication line, and a sales management method of gaming machines using the communication unit.

2. Description of the Related Art

Conventionally, in a store (for example, a game arcade, a pachinko hall or the like) where a plurality of gaming machines are installed, every day, after the business hours of the shop are over, a store clerk grasps a sales amount of each gaming machine by confirming data which a coin selector or the like mounted on each gaming machine indicates. However, such an operation to grasp the sales amount after the business hours are over every day gives rise to a drawback that the store cannot grasp the transition of sales amount or the like. Further, since the store management is performed without grasping the transition of the sales amount or the like, there also arises a drawback that the store cannot offer proper services which satisfy needs of customers.

To overcome such a drawback, conventionally, there has been proposed a gaming system (for example, Japanese Patent Laid-open 2003-331085, hereinafter referred to as patent document) which allows a store to grasp a sales amount of each gaming machine in real time. That is, RFID tags are attached to a plurality of respective premiums accommodated in the inside of the gaming machine. Then, data which indicates a kind of the premium taken out from the gaming machine is obtained by reading the RFID tag attached to the premium using a reader mounted on the gaming machine. Thereafter, the data is collected and managed so as to allow the store to grasp the sales amount of each gaming machine in real time.

### SUMMARY OF THE INVENTION

However, to grasp the sales amount of the store and the transition of the sales amount using the gaming system described in the above-mentioned patent document, it is necessary that equipments such as the readers are mounted on all gaming machines installed in the store. However, there is hardly a case that all gaming machines which are installed in the store are manufactured by the same game maker. That is, the gaming machines installed in the store are manufactured by different game makers. Accordingly, there has been a drawback that the construction of the gaming system is difficult.

Further, with respect to a large game arcade which installs a large number of gaming machines therein or a major game arcade which manages a large number of stores which require the store management using a communication line or the like, to grasp the sales amount, the transition of sales amount and the like using the gaming system described in the above-mentioned patent document may bring large advantages. However, the system is not always necessary in a small gaming arcade which manages only one store and hence, when the equipment such as readers are preliminarily mounted on all gaming machines, there arises a drawback that the construction of the system becomes rather costly for the small game arcade.

Further, when the equipment such as the readers are preliminarily mounted on all gaming machines, even when the equipments such as readers are mounted on the gaming machines which are removed from the store, it is impossible to recycle the equipment and hence, it is necessary to purchase the equipment such as the readers each time the store purchases the gaming machines whereby the cost for construction and the management of the system is pushed up.

The present invention has been made under such circumstances and it is an object of the present invention to provide a communication unit and a sales management method of gaming machines using a communication unit which, in a store where a plurality of gaming machines which are manufactured by different game makers are installed, can construct a system which allows the store to grasp the sales amount in real time and, at the same time, can allow the store side to arbitrarily select the construction or the non-construction of the above-mentioned system depending on the size of the store.

It is also an object of the present invention to provide a communication unit and a sales management method of gaming machines using a communication unit which can reduce a cost for constructing and running the above-mentioned system.

According to a first aspect of the present invention, there is provided a communication unit which is connectable with gaming machines and a server which manages a store in which the gaming machines are installed through a communication line, the communication unit comprising: identification information storing means which stores identification information respectively allocated to the gaming machines; sales information storing means which stores sales information on sales amounts of the gaming machines; receiving means which receives a signal outputted from the gaming machine when one of at least two different value gaming mediums is detected or read by the gaming machine; sales information updating means which updates the sales information stored in the sales information storing means in response to the signal received by the receiving means; and sales information transmitting means which transmits the sales information stored in the sales information storing means together with the identification information stored in the identification information storing means to the server through the communication line.

According to a second aspect of the present invention, there is provided a sales management method of gaming machines using a communication unit which is connectable with the gaming machines and a server which manages a store in which the gaming machines are installed through the communication line, the sales management method comprising the steps of: storing identification information respectively allocated to the gaming machines; storing sales information on sales amounts of the gaming machines; receiving a signal outputted from the gaming machine when one of at least two different value gaming mediums is detected or read by the gaming machine; updating the sales information stored in the sales information storing means in response to the signal received by the receiving means; and transmitting the sales information stored in the sales information storing means together with the identification information stored in the identification information storing means through the communication line.

In the above-mentioned communication unit and the sales management method of gaming machines using a communication unit according to the first and second aspects of the present invention, as the value gaming mediums which differ in the content of value, it is possible to use various kinds of mediums having the value of content such as coins, token, prepaid cards, cash card and the like. Further, these value gaming medium scan be used in desired combination.

Particularly, when coins which are inserted into the gaming machine and value information which is stored in a predetermined storage medium are used as the value gaming mediums, the receiving means receives a signal outputted from the gaming machine when the coin is inserted into the gaming machine or when the value information is read by the gaming machine through the communication line.

According to a third aspect of the present invention, there is provided a sales management method of gaming machines using a communication unit which is connectable with the gaming machines and a server which manages a store in which the gaming machines are installed through the communication line, the sales management method comprising the steps of: receiving identification information which are respectively allocated to the gaming machines and address information which are provided for allowing the communication unit to perform the communication with the server from a portable terminal; storing the identification information; and storing the address information.

According to a fourth aspect of the present invention, there is provided a portable terminal capable of performing the transmission/reception of data with the above-mentioned communication unit and including inputting means, storing means and display means, wherein the portable terminal comprises: display control means which allows display means to display an inputted image which allows the inputting of the identification information and the address information through the inputting means based on image data for inputted image stored in the storing means; and set information transmitting means which transmits the identification information and the address information which are inputted through the inputting means when the inputted image is displayed on the display means to the communication unit.

### BRIEF DESCRIPTION OF THE DRAWINGS

FIG. 1 is a front view which schematically shows one example of gaming machines in which a communication unit according to the first embodiment of the present invention is mounted;

FIG. 2 is a network constitutional view showing one example of a store management system which is constituted of the communication unit according to the first embodiment of the present invention, the gaming machine in which the communication unit is mounted, and a server which manages a store in which the gaming machine is installed;

FIG. 3 is a block diagram showing the inner structure of the communication unit according to the first embodiment of the present invention;

FIG. 4 is a block diagram showing the inner structure of the server which constitutes the store management system according to the first embodiment of the present invention;

FIG. 5 is a flow chart showing a sub routine of the processing which is performed in the communication unit according to the first embodiment of the present invention;

FIG. 6 is a view showing one example of the sales information stored in a memory which the communication unit according to the first embodiment of the present invention includes;

FIG. 7 is a view showing one example of the sales information stored in a hard disc which the server according to the first embodiment of the present invention includes;

FIG. 8A and FIG. 8B are views showing one example of the total sales amount information displayed on the server according to the first embodiment of the present invention;

FIG. 9 is a front view which schematically shows one example of gaming machines in which a communication unit according to the second embodiment of the present invention is mounted;

FIG. 10 is a network constitutional view showing one example of a store management system which is constituted of the communication unit according to the second embodiment of the present invention, the gaming machine in which the communication unit is mounted, and a server which manages a store in which the gaming machine is installed;

FIG. 11 is a block diagram showing the inner structure of the communication unit according to the second embodiment of the present invention;

FIG. 12 is a block diagram showing the inner structure of a mobile phone according to the second embodiment of the present invention;

FIG. 13 is a block diagram showing the inner structure of the server which constitutes the store management system according to the second embodiment of the present invention;

FIG. 14 is a flow chart showing a sub routine of the processing which is performed in the communication unit according to the second embodiment of the present invention;

FIG. 15 is a flow chart showing the initializing processing which is performed in the communication unit and the mobile phone according to the second embodiment of the present invention; and

FIG. 16A to FIG. 16C are views showing one example of an input image displayed on the mobile phone when the initializing processing shown in FIG. 15 is performed.

### DESCRIPTION OF THE PREFERRED EMBODIMENTS

Hereinafter, a communication unit and a sales management method of gaming machines using a communication unit are explained in detail in conjunction with embodiments shown in attached drawings.

### First Embodiment

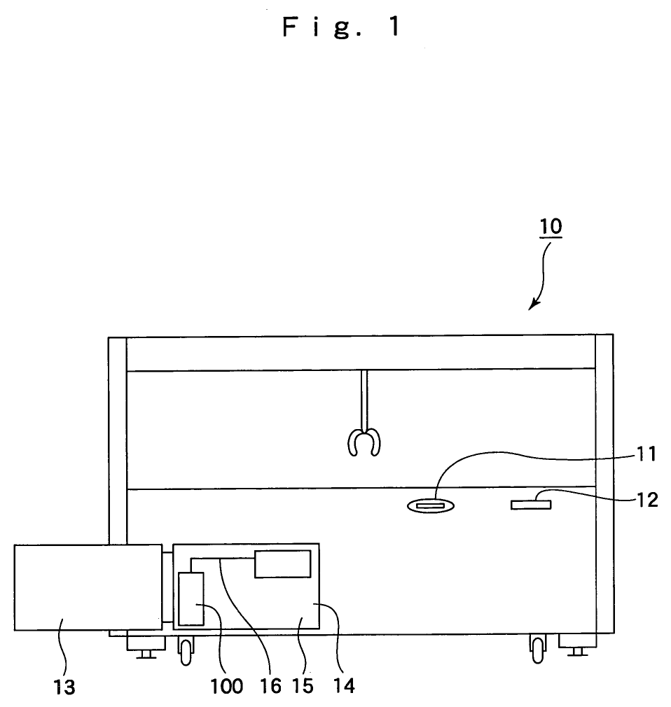

FIG. 1 is a front view which schematically shows one example of a gaming machine in which a communication unit according to the first embodiment of the present invention is mounted. The gaming machine 10 is a prize game which allows a player to acquire a premium such as a doll (not shown in the drawing) which is accommodated in the inside of the machine by gripping the doll with a crane. On a right side of a front surface of the gaming machine 10 as viewed from the center of the gaming machine 10, a coin insertion opening 11 into which coins are inserted and a card insertion opening 12 into which a prepaid card is inserted are provided.

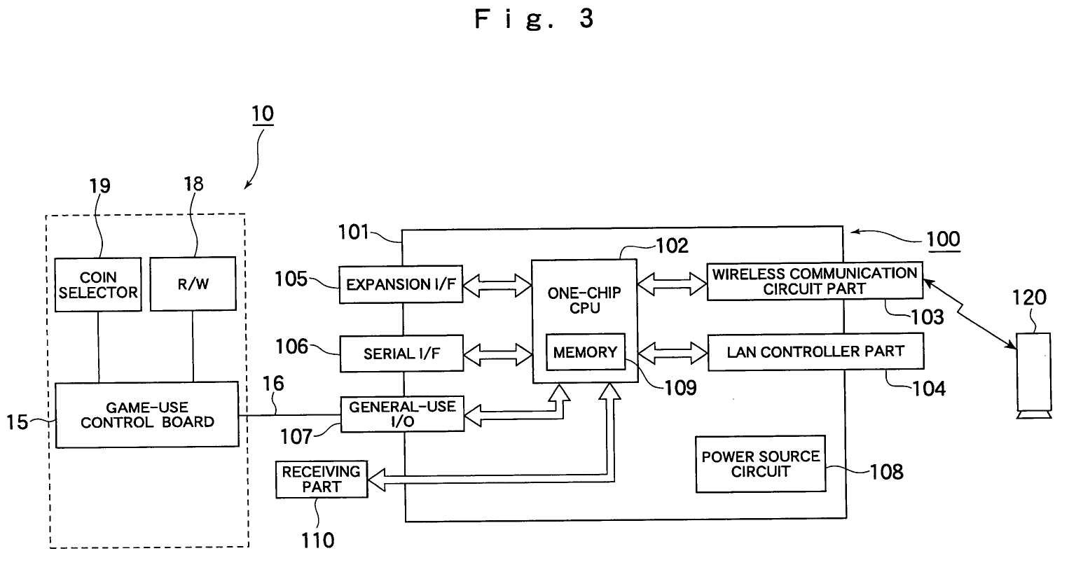

In the inside of the coin insertion opening 11, a coin selector 19 (see FIG. 3) which detects the coin inserted in the coin insertion opening 11 is formed. The coin selector 19 outputs a detection signal when the coin selector 19 detects the coin inserted through the coin insertion opening 11. Here, the coins used in the present invention include value gaming mediums such as medals, game-use coins, tokens and the like.

In the inside of the card insertion opening 12, a R/W (reader/writer) 18 (see FIG. 3) is arranged. When the prepaid card which stores money information is inserted into the card insertion opening 12, the R/W 18 reads the money information from the prepaid card and performs an operation to deduct a predetermined amount from an amount which the money information indicates and writes the money information which indicates the amount information after deduction. The R/W 18 also outputs a notification signal upon completion of the above-mentioned processing.

Here, the above-mentioned prepaid card corresponds to a storing medium according to the present invention. In the present invention, the storing medium is not limited particularly to the above-mentioned prepaid card and, for example, a card having magnetic stripes, an IC card and the like can be used as the storing medium. Further, the value information stored in the above-mentioned storing medium is not particularly limited and money information which indicates a money amount, information which indicates a predetermined point number and the like can be used as the value information. Further, as the R/W 18, conventionally known equipment corresponding to the storing medium can be adopted.

On a left side of a lower portion of the front surface of the gaming machine 10, a maintenance door 13 is mounted. In FIG. 1, the maintenance door 13 is shown in an opened state. In the gaming machine 10, a maintenance box 14 is mounted on a front surface of the maintenance door 13, while a game-use control printed circuit board 15 and a communication unit 100 are mounted on the maintenance box 14. Further, the game-use control printed circuit board 15 and the communication unit 100 are connected with each other using a harness 16.

Although the explanation is made with respect to a case in which the communication unit 100 is mounted in a prize gaming machine in this embodiment, the gaming machine in which the communication unit of the present invention is mounted is not particularly limited provided that the gaming machine can perform a game based on the coins or the value information stored in the storing medium (for example, a prepaid card or the like). For example, as such a gaming machine, for example, a video gaming machine, a medal gaming machine, a music gaming machine, an amusement vendor (a machine which takes small photo stickers) and the like can be named.

Further, although the explanation is made with respect to a case in which the communication unit 100 is mounted in the inside of the maintenance box 14 in this embodiment, that is, in the inside of the gaming machine 10, the communication unit of the present invention may be mounted outside the gaming machine. When the communication unit of the present invention is mounted outside the gaming machine, in performing the communication between the communication unit and the server which manages the store by wireless, there is no possibility that the electric wave is attenuated by a casing of the gaming machine thus ensuring a favorable electric wave state. However, when it is possible to ensure the favorable electric wave state even when the communication unit is mounted in the inside of the gaming machine, it is preferable to mount the communication unit in the inside of the gaming machine as in the case of this embodiment. This is because that it is possible to conceal the communication unit from the player and hence, it is possible to prevent an illegal action such as mischief against the communication unit while preventing the player from suspecting the presence of the communication unit. Further, it is possible to connect the communication unit with equipment inside the gaming machine (for example, the game-use control printed circuit board or the like) using a harness or the like and hence, it is unnecessary to form holes in the casing of the gaming machine or the like thus bringing about an advantage that the communication unit can be easily mounted.

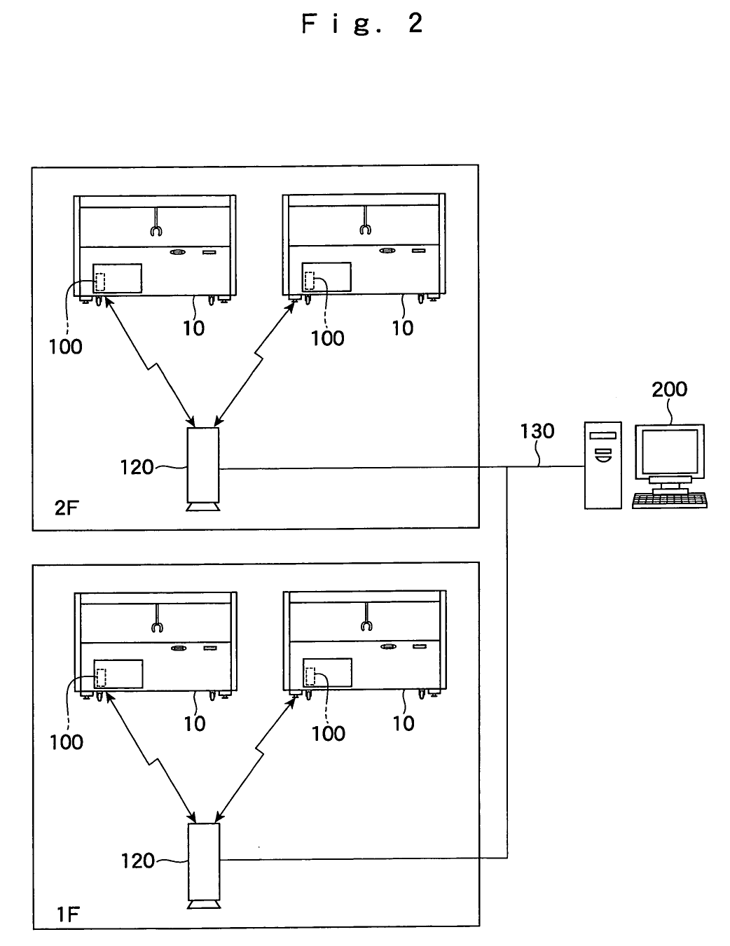

FIG. 2 is a network constitutional view showing one example of a store management system which is constituted of the communication unit according to the first embodiment of the present invention, the gaming machine in which the communication unit is mounted, and the server which manages a store in which the gaming machine is installed. It is needless to say that the number of gaming machines installed in the store and the number of floors of the store are not limited to the example shown in FIG. 2.

On the first floor of the store, two gaming machines 10 which mount the communication unit 100 therein and an access point 120 (an electric wave relay) are installed. Also on the second floor of the store, two gaming machines 10 and an access point 120 are installed in the same manner. The respective access points 120 are connected with the server 200 through a cable 130.

In this embodiment, the explanation is made with respect to the case in which a local area network (LAN) is constituted by communicably connecting the communication units 100 and the server 200 through the access points 120, the communication between the communication units 100 and the access points is performed by wireless, and the communication between the access points 120 and the server 200 is performed by wire. However, the present invention is not limited to such a case. For example, the communication units 100 and the server 200 may be allowed to be communicable with each other by wire or the communication units 100 and the server 200 may be allowed to be communicable with each other by wireless.

The communication line used in this embodiment includes not only a transmission line constituted of wire but also a transmission line constituted of wireless. A transmission method which is performed between the communication units 100 and the server 200 is not particularly limited and can be suitably selected. Further, in the store management system according to this embodiment, an infrastructure mode in which the communication units 100 and the server 200 are communicated with each other while relaying the access points 120 is adopted. However, the communication line of this embodiment may adopt an ad hoc mode which does not use the access point as relay points as the transmission method. Further, the communication line of this embodiment may adopt either one of a bridge type and a router type as a type of the access points 120.

FIG. 3 is a block diagram showing the inner structure of the communication unit according to the first embodiment of the present invention. In the drawing, for facilitating the understanding of the invention, as equipment provided to the gaming machine 10, only the game-use control printed circuit board 15, the R/W 18 and the coin selector 19 are shown. It is needless to say, however, that the gaming machine 10 includes other peripheral equipment. The communication unit 100 is constituted of a body 101 and a receiving part 110. The body 101 includes a one-chip CPU having a memory (RAM) (hereinafter simply referred to as “CPU”) 102, wherein a wireless communication circuit part 103, a LAN controller part 104 and an expansion I/F 105, a serial I/F 106 and a general-purpose I/O 107 are connected to the CPU 102. Further, a body 101 includes a power source circuit 108.

The game-use control printed circuit board 15 of the gaming machine 20 is connected to the general-use I/O 107 through the harness 16. The R/W 18 and the coin selector 19 are connected to the game-use control printed circuit board 15. A notification signal is outputted to the game-use control printed circuit board 15 from the R/W 18 when the R/W 18 performs the processing of reading money information from a prepaid card, deducting a predetermined amount from an amount which the money information indicates and writing money information indicative of a money amount after deduction and, thereafter, is inputted to the general-purpose I/O 107 through the harness 16 from the game-use control printed circuit board 15. A detection signal which is outputted to the game-use control printed circuit board 15 from the coin selector 19 when the coin selector 19 detects a coin is inputted to the general-purpose I/O 107 through the harness 16 from the game-use control printed circuit board 15. The communication signal or the detection signal inputted to the general-purpose I/O 107 is inputted to the CPU 102. Here, in this embodiment, although the explanation is made with respect to the case in which the communication unit 100 is connected with the game-use control printed circuit board 15 of the gaming machine 10, the communication unit 100 may be connected with the coin selector 19 and/or the R/W 18. By constructing the communication unit 100 in this manner, the communication unit 100 can directly receive the signal (the detection signal or the notification signal) from the coin selector 19 and/or the R/W 18.

In a portion of the storage region of the memory 109, data for performing the communication with the server 200, for example, address information (for example, an IP address or the like) for allowing the communication between the server 200 and the communication units 100, codes which are respectively allocated to the communication units 100, identification information which are respectively allocated to the gaming machines 10, an identifier of the network (for example, ESSID or the like), information for ciphering communication data using a predetermined ciphering method (for example, WEP, WPA or the like) or the like are stored. In this manner, the memory 109 functions as identification information storage means which stores the identification information which are respectively allocated to the gaming machines 10.

Further, in a portion of the storage region of the memory 109, as the sales information relevant to the sales amount of the gaming machine 10, first sale information relevant to the sales amount attributed to the coins and second sale information relevant to the sales amount attributed to the value information are respectively stored. The sales information contains an amount of coins or value information used in the gaming machine 10 and points of time at which the coins or the value information are used. Here, when an amount of the coins or the value information used in the gaming machine 10 is a fixed amount (for example, when the amount is 100 yen for one game), as the sales information, only the points of time at which the coins or the value information are used maybe stored. In this manner, the memory 109 functions as sales information storing means which stores the sales information relevant to the sales amount in the gaming machine 10 and is capable of respectively storing the first sales information relevant to the sales amount attributed to the coins and the second sales information relevant to the sales amount attributed to the value information.

Further, a ROM (not shown in the drawing) is incorporated in the CPU 102 and a program for realizing the function of the communication unit 100 is stored in the ROM. The CPU 102 reads and executes the program so as to perform following processing (A) to (C).

(A) The CPU 102 receives a signal which is outputted from the gaming machine 10 when the coin which is inserted into the gaming machine 10 is detected by the gaming machine 10 or when the value information is read from the storage medium (for example, the prepaid card or the like) by the gaming machine 10 by the general-purpose I/O 107 through the harness 16. In such an operation, the CPU 102 receives the detection signal which is outputted from the gaming machine 10 when the coin inserted in the gaming machine 10 is detected by the gaming machine 10 and the notification signal which is outputted from the gaming machine 10 when the value information is read from the prepaid card by the gaming machine 10 as signals which differ from each other. Here, the CPU 102 functions as the receiving means.

(B) The CPU 102 updates the sales information stored in the memory 109 (sales information storing means) based on the signal received by the gaming machine 10. In such an operation, the CPU 102 functions as the sales information updating means. Here, the CPU 102 updates the first sales information upon receiving the detection signal and updates the second sales information upon receiving the notification signal.

(C) The CPU 102 transmits the sales information stored in the memory 109 (sales information storing means) together with the identification information stored in the memory 109 (identification information storing means) to the server 200 through a wireless communication circuit part 103 using an access point 120 as a relay. Here, the CPU 102 functions as the sales information transmitting means.

The wireless communication circuit part 103 enables the transmission/reception of data between the communication unit 100 and the server 200 by wireless. As the wireless communication circuit part 103, a card type expansion device such as a PCMCIA type card, a MiniPCI type card, for example, can be adopted. Further, the LAN control part 104 enables the transmission/reception of data between the communication unit 100 and the server 200 by wire.

Various peripheral equipment can be connected to the expansion I/F 105. A serial I/F 106 is an interface for performing the serial transmission and can adopt a serial transmission method such as RS-232, RS-422 or the like. Further, the receiving part 110 is connected to the CPU 102 of the body 101. The receiving part 110 is provided for performing the infrared ray communication with a portable terminal (for example, a mobile phone or the like).

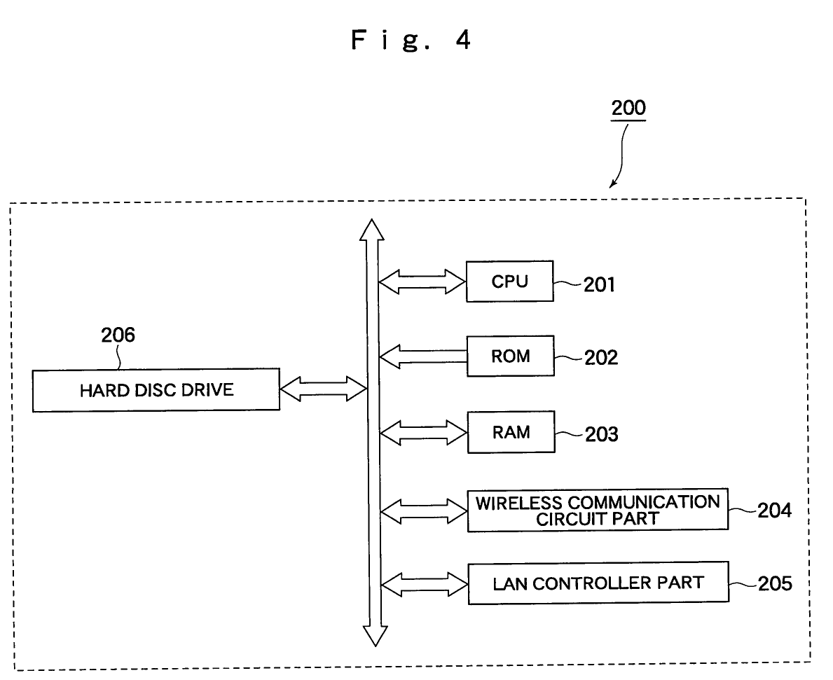

FIG. 4 is, in this embodiment, a block diagram showing the inner constitution of the server 200 which constitutes the store management system. The server 200 includes a CPU 201 which constitutes an arithmetic processing device, a ROM 202, a RAM 203, a wireless communication circuit part 204, a LAN controller part 205, and a hard disc drive 206. The wireless communication circuit part 204 receives the sales information of the gaming machines 10 and the identification information which are respectively allocated to the gaming machines 10 from the communication unit 100 through the access point 120. The hard disc drive 206 stores the sales information received from the communication unit 100 for respective identification information respectively allocated to the gaming machines 10.

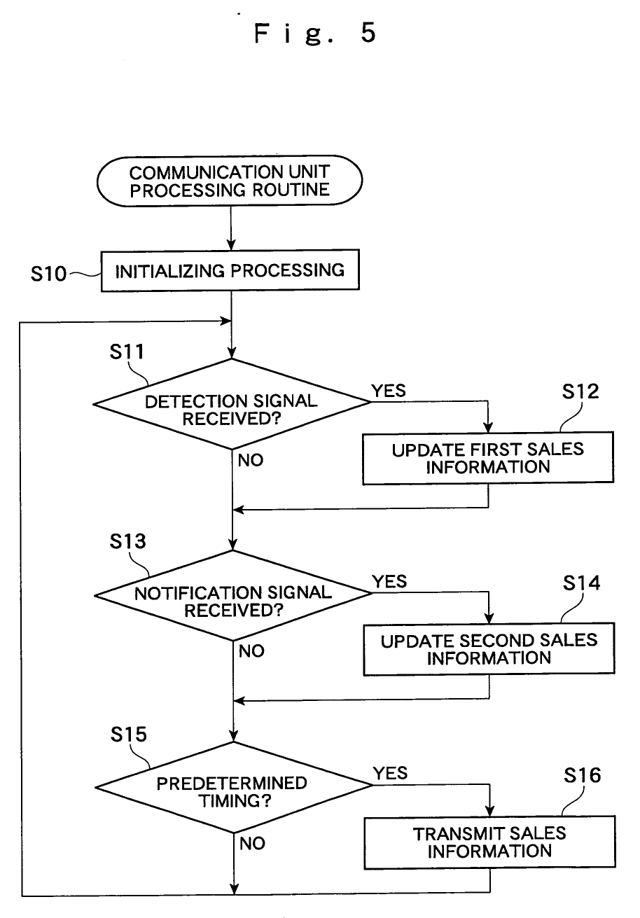

FIG. 5 is a flow chart showing a sub routine of the processing performed in the communication unit 100. First of all, the CPU 102 performs the initializing processing (step S10). This processing includes processing which allows the communication unit 100 to receive the data from the outside (for example, a mobile phone or the like) using the infrared ray communication through the receiving part 110 or the like and allows the memory 109 to store the data necessary for performing the communication between the gaming machine 10 and the server 200 based on the data, the setting of points of time and the like. The data for allowing the communication between the communication units 100 and the server 200 includes, for example, the address information (for example, IP address or the like) for allowing the communication between the communication unit 100 and the server 200, codes which are respectively allocated to the communication units 100, the identification information which are respectively allocated to the gaming machine 10 100, the identifier of the network (for example, ESSID or the like), the information for performing the ciphering of the communication data using a predetermined ciphering method (for example, WEP, WPA or the like) and the like. Further, the processing for setting points of time is processing which sets points of time at which the detection signal or the notification signal is received from the gaming machine 10 and records such received points of time.

Next, the CPU 102 determines whether the CPU 102 receives the detection signal from the gaming machine 10 or not (step S11). The detection signal is a signal which is outputted from the coin selector 19 through the game-use control printed circuit board 15 when the coin which is inserted into the coin inserting port 11 of the gaming machine 10 is detected by the coin selector 19 and is inputted to the CPU 102 through the harness 16 and the general-purpose I/O 107. When the CPU 102 executes the processing in step S11, the CPU 102 functions as the detection signal receiving means.

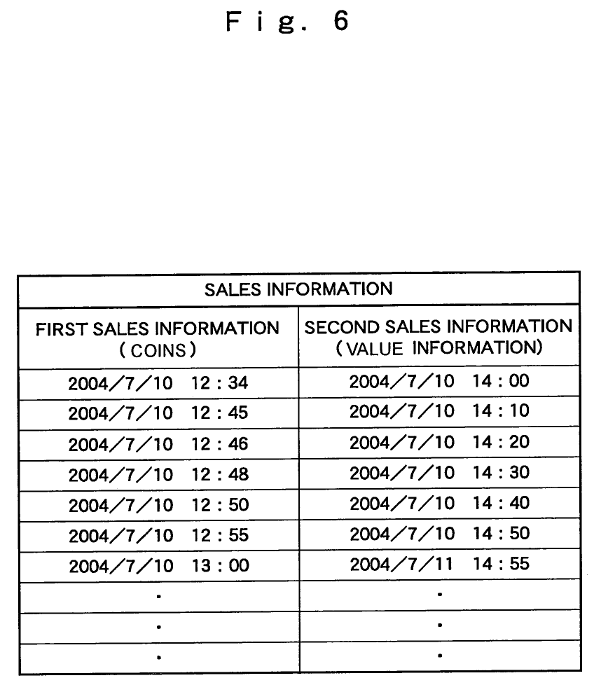

When it is determined that the detection signal is received in step S11, the CPU 102 performs the processing to update the first sales information stored in the memory 109 based on the detection signal (step S12). FIG. 6 is a view showing one example of the sales information stored in the memory 109 provided to the communication unit 100. The sales information is constituted of the first sales information relevant to the sales amount attributed to the coins and the second sales information relevant to the sales amount attributed to the value information. The points of time at which the detection signals are received are stored as the first sales information, while the points of time at which the notification signals are received are stored as the second sales information. In step S12, the CPU 102 allows the memory 109 to store the points of time at which the detection signals are received as the first sales information. Here, the CPU functions as the sales information updating means.

When it is determined that the detection signal is not received in step S11 or the processing in step S12 is executed, the CPU 102 determines whether the CPU 102 receives the notification signal from the gaming machine 10 or not (step S13). The notification signal is a signal which is outputted from the R/W 18 when the R/W 18 performs the processing of reading money information from a prepaid card inserted into the card insertion port 12 of the gaming machine 10, deducting a predetermined amount from an amount which the money information indicates and writing money information indicative of an amount after deduction into the prepaid card and is outputted to the CPU 102 through the harness 16 and the game-use control printed circuit board 15. In executing the processing in step S13, the CPU 102 functions as the notification signal receiving means.

When it is determined that the notification signal is received in step S13, the CPU 102 performs the processing to update the second sales information stored in the memory 109 in response to the notification signal (step S14). In this processing, the CPU 102 stores the points of time at which the notification signals are received as the second sales information to the memory (see FIG. 6). Here, the CPU 102 functions as the sales information updating means.

When it is determined that the detection signal is not received in step S13 or when the processing in step S14 is executed, the CPU 102 determines whether a predetermined timing arrives or not (step S15). Here, the predetermined timing is not particularly limited and may be, for example, a predetermined cycle (for example, every 10 minutes or every 1 hour or the like) or a predetermined condition (timing that the sales information is updated, timing that the sales amount which the sales information indicates reaches a predetermined amount, timing that the a request signal which requests the transmission of the sales information is received from the server).

In step S15, when it is determines that the predetermined timing arrives, the CPU 102 transmits the sales information stored in the memory 109 together with the identification information of the gaming machine 10 stored in the memory to the server 200 through the access point 120 from the wireless communication circuit part 103 (step S16). Here, the CPU 102 functions as the sales information transmitting means which transmits the sales information stored in the memory 109 (sales information storing means) to the server 200 together with the identification information of the gaming machine 10 stored in the memory 109 (identification information storing means) through the communication line. Thereafter, the processing returns to step S11 and the processing in step S11 to S16 is repeated. Here, the sales information which is transmitted to the server 200 among the sales information stored in the memory 109 may be readily deleted from the memory 109, may be deleted at the predetermined timing, or may be deleted when an instruction indicative of the deletion of the data is inputted from the outside (for example, a mobile phone, the server or the like).

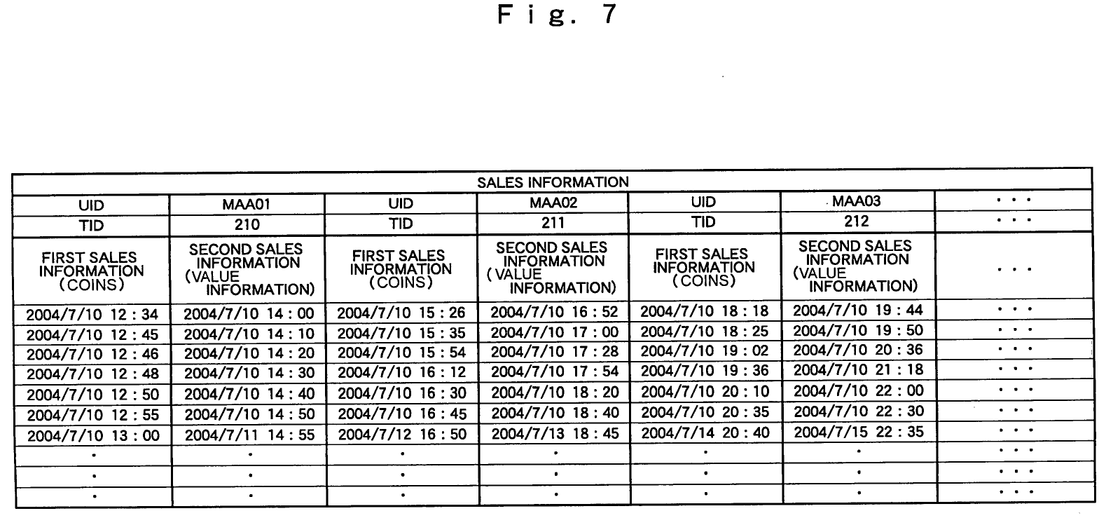

When the processing shown in FIG. 6 is executed with respect to the communication units 100 of the respective gaming machines 10 installed in the store and the sales information are transmitted to the server 200, the sales information are managed in the server 200 as shown in FIG. 7. FIG. 7 shows one example of the sales information stored in the hard disc drive 206 provided to the sever 200. In the drawing, symbol “UID” indicates names and numbers of the gaming machines 10 in the store and symbol “TID” indicates ID data (numbers) which are respectively allocated to the communication units 100 in the store. Here, “UID” corresponds to the identification information respectively allocated to the gaming machines.

In the hard disc drive 206 of the server 200, as shown in FIG. 7, for every gaming machine 10, that is, for every identification information “UID” which is respectively allocated to the gaming machine 10, the ID data “TID” which is respectively allocated to the communication unit 100 and the sales information consisting of the first sales information and the second sales information are stored.

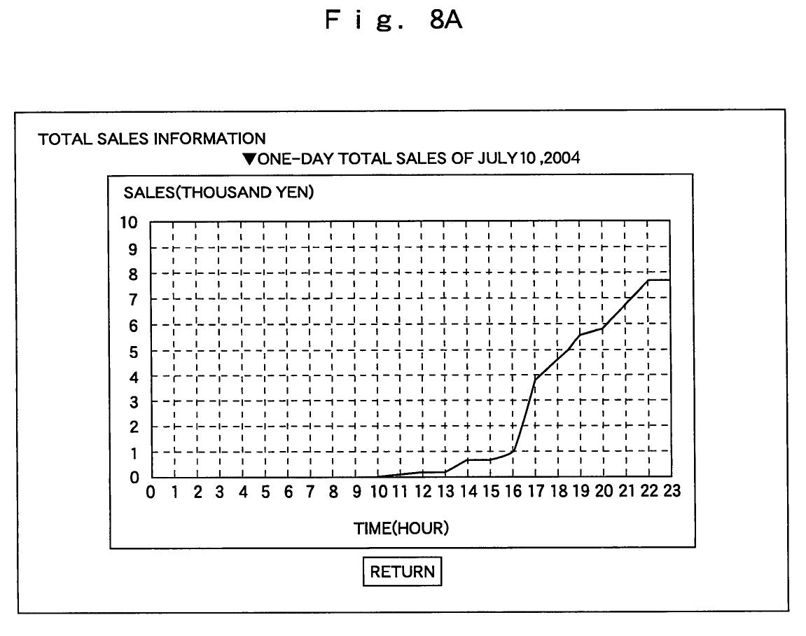

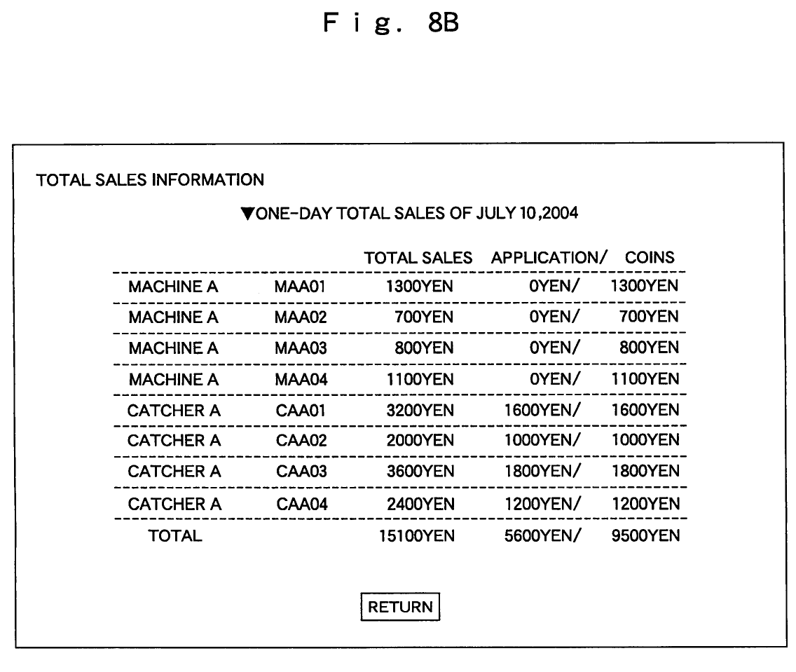

As shown in FIG. 7, since the sales information is stored in the hard disc drive 206 of the server 200, by editing the sales information, it is possible to obtain the total sales information as shown in FIG. 8A and FIG. 8B. FIG. 8A and FIG. 8B are views which respectively show one example of the total sales information respectively. FIG. 8A shows the total sales information which indicates the transition of the sales amount of the store which is edited based on the sales information (the first sales information and the second sales information) of all gaming machines 10 in the store. FIG. 8B shows the total sales information which indicates the sales amount in the respective gaming machines 10, that is, the sales amount attributed to the coins and the sales amount attributed to the value information edited based on the sales information of the respective gaming machines 10 in the inside of the store. Here, in the drawing, “APPLICATION” indicates the sales amount attributed to the value information and “COIN” indicates the sales amount attributed to the coins. It is needless to say that the total sales information which can be edited based on the sales information in the present invention is not limited to the above-mentioned example.

As described above, according to the communication unit 100, the communication unit 100 can be connected with the gaming machine 10 and the server 200 through the communication line, receives the detection signal or the notification signal from the gaming machine 10 and stores the sales information relevant to the sales amount, and transmits the sales information to the server 200 at the predetermined timing, whereby it is possible to construct the store management system which is capable of grasping the sales amount in real time by mounting the communication units 100 in the respective gaming machines 10 (see FIG. 2). Further, since the communication unit 100 is provided separately from the gaming machine 10, it is possible to install the communication unit 100 in the respective gaming machines 10 which are manufactured by the different game makers. Still further, since the communication unit 100 is provided separately from the gaming machine 10, the store side can arbitrarily select the construction or the non-construction of the store management system depending on the size of the store. Further, it is possible to construct the store management system by installing the communication units 100 in the existing gaming machines 10 and hence, the cost for constructing the system can be reduced. Still further, the communication unit 100 is detachable from the gaming machine 10 and is attachable to a newly introduced gaming machine. It is therefore possible for the store to decide whether or not they maintain the system and hence, the cost for running the system can be reduced.

It is preferable that the communication unit 100 according to this embodiment stores the first sales information relevant to the sales amount attributed to the coins and the second sales information relevant to the sales amount attributed to the value information respectively, updates these sales information, and transmits the updated sales information to the server 200. That is, it is preferable that the communication unit 100 has the following constitution. The sale information storing means (for example, the memory 109) is capable of storing the first sales information relevant to the sales amount attributed to the coins and the second sales information relevant to the sales amount attributed to the value information respectively. On the other hand, the receiving means (for example, CPU 102) includes detection signal receiving means which receives the detection signal outputted from the gaming machine 10 when the coins which are inserted in the gaming machine are detected by the gaming machine, and the notification signal receiving means which receives the notification signal which is outputted from the gaming machine when the value information is read from the predetermined storing medium by the gaming machine. The sales information updating means (for example, the CPU 102) updates the first sales information stored in the sales information storing means based on the detection signal received by the detection signal receiving means and, at the same time, updates the second sales information stored in the identification information storing means based on the notification signal received by the notification signal receiving means.

Since the sales amount attributed to the coins and the sales amount attributed to the value information can be grasped respectively (see FIG. 8B), it is possible to smoothly carry out the store management by, for example, taking out the coins when the sales amount attributed to the coins arrives at the predetermined amount.

As has been described heretofore, according to the first embodiment of the present invention, due to the communication units which are connectable with the gaming machines and the server through the communication line, the sales information relevant to the sales amount of the gaming machines are stored in the communication units, and are transmitted to the server from the communication units and hence, by setting the communication unit to the respective gaming machines, it is possible to construct the system which can grasp the sales amount in real time. Further, since the communication unit is formed separately from the gaming machine, it is possible to mount the communication units in the respective gaming machines which are manufactured by the different game makers whereby it is possible to construct the system which can grasp the sales amount in real time in the store where the plurality of gaming machines which are manufactured by the different game makers are installed. Further, since the communication unit is provided separately from the gaming machine, the store side can arbitrarily select the construction or the non-construction of the store management system depending on the size of the store. Further, it is possible to construct the store management system by installing the communication units in the existing gaming machines and hence, the cost for constructing the system can be reduced. Still further, the communication unit 100 is detachable from the gaming machine 10 and is attachable to a newly introduced gamine machine. It is therefore possible for the store to decide whether or not they maintain the system and hence, the cost for running the system can be reduced.

Further, according to the first embodiment of the present invention, since the sales amount attributed to the coins and the sales amount attributed to the value information (for example, the money information or the like which is readable from the prepaid card or the like) can be grasped respectively, it is possible to smoothly carry out the store management by, for example, taking out the coins when the sales amount attributed to the coins arrive at the predetermined amount.

### Second Embodiment

As described heretofore, the first embodiment of the present invention provides the communication units which are mounted in respective gaming machines separately from the gaming machines, collect the sales amounts of the gaming machines and can transmit the sales amount information to the server. According to such communication units, since the communication units can be arbitrarily and detachably mounted on the store side, in the store where the plurality of gaming machines which are manufactured by different game makers are installed, it is possible to construct the system which is capable of grasping the sales amounts in real time and, at the same time, the store side can arbitrarily select the construction or the non-construction of the system depending on the size of the store. Further, it is possible to reduce the cost for constructing and managing the system.

However, to mount the respective gaming machines in the above-mentioned communication units, for example, it is necessary to respectively set the information for communication such as the identification information for identifying the gaming machines, the address information for allowing the communication units per se to perform the communication with the server. Accordingly, when button switches, a display or the like are provided to the communication unit, the manufacturing cost is slightly pushed up.

The second embodiment is made under such circumstances and it is an object of the present invention to provide a communication unit, a portable terminal which is capable of performing the transmission/reception of data with the communication unit, and a sales management method using communication units which can reduce a cost and time for constructing a system which is capable of grasping the sales amounts in real time in a store where a plurality of gaming machines which are manufactured by different gaming makers are installed,

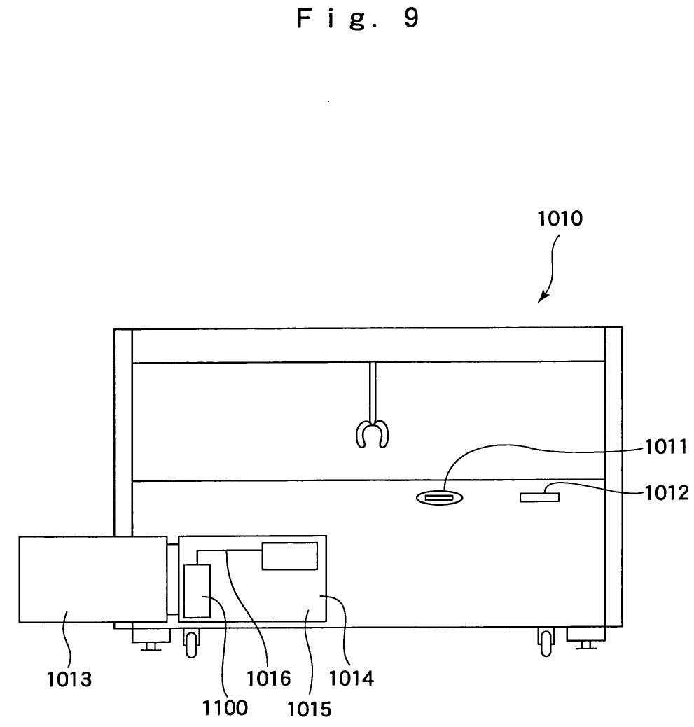

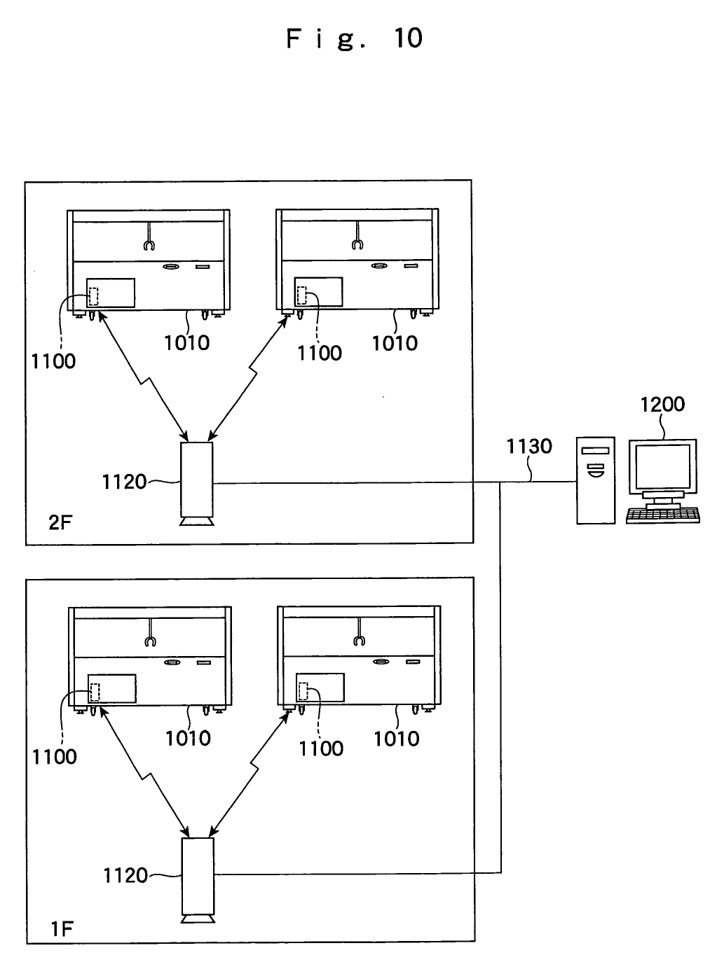

FIG. 9 is a front view which schematically shows one example of a gaming machine in which a communication unit according to the second embodiment of the present invention is mounted, while FIG. 10 is a network constitutional view showing one example of a store management system of the second embodiment. Since these gaming machine and the store management system are substantially equal to the gaming machine and the store management system of the first embodiment except for the utilization of the portable terminal. Accordingly, like parts are indicated by the same numeral while adding 1000 and the detailed explanation of these parts is omitted except for the following explanation relevant to the portable terminal equivalent.

When the communication unit of the present invention is mounted outside the gaming machine, it is possible to adopt the infrared rays as a communication medium for performing the communication with the portable terminal. Further, when an electric wave is adopted as the communication medium for performing the communication with the portable terminal, there is no possibility that the electric wave is attenuated by an outer wall of a casing of the gaming machine thus ensuring a favorable electric wave state.

As described above, in installing the communication unit in the inside of the gaming machine, it is desirable to adopt the electric wave as the communication medium for performing the communication between the communication unit and the gaming machine. This is because that it is possible to perform the setting of the identification information and the address information from the portable terminal in a state that the communication unit is mounted in the inside of the gaming machine without opening a door (for example, a maintenance door 1013) which is provided to the gaming machine and hence, it is possible to prevent an illegal action (for example, the installation of illegal equipment, picking of money from the inside of the gaming machine and the like). Further, in setting the identification information and the address information, it is unnecessary for a shop manager to stand on a site thus reducing time and efforts necessary for constructing the system.

In mounting the communication unit in the inside of the gaming machine, it is also possible to adopt the infrared rays as the communication medium for performing the communication between the communication unit and the gaming machine. In this case, before mounting the communication unit in the inside of the gaming machine, the identification information or the address information may be preliminarily set in the communication unit from the portable terminal using the infrared ray communication (for example, 1rDA or the like). Further, by mounting a sensor which detects the infrared rays on the communication unit, the sensor may be exposed outside the gaming machine.

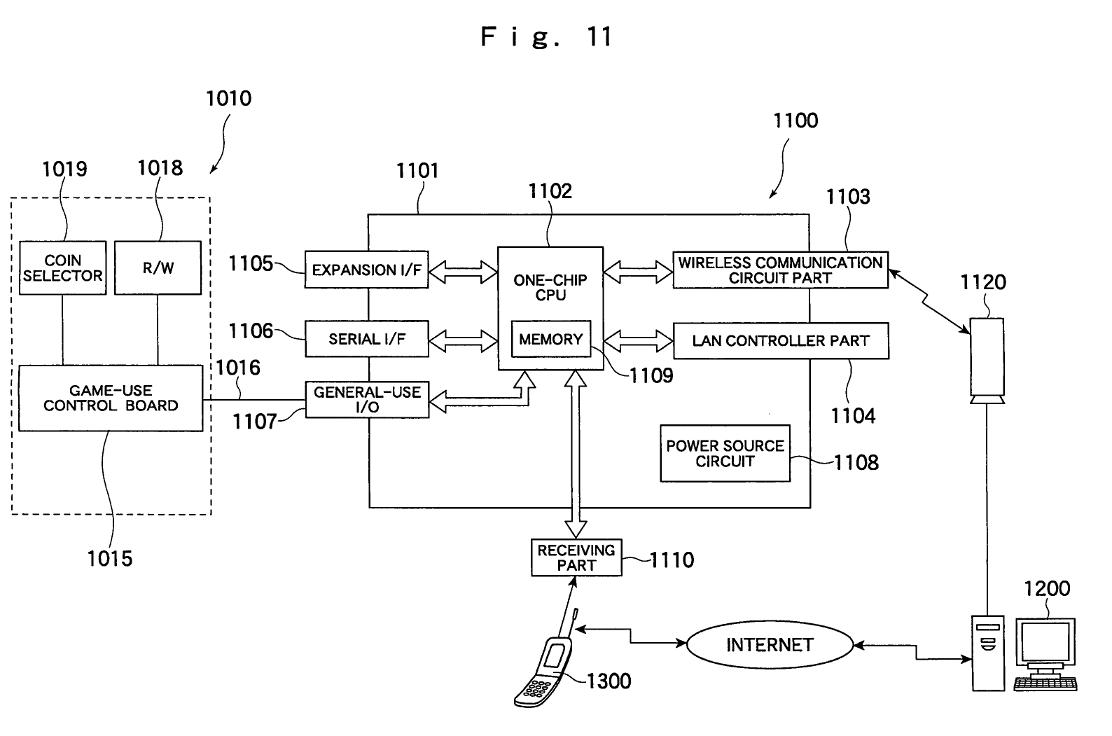

FIG. 11 is a block diagram showing the inner structure of the communication unit according to the first embodiment of the present invention. In the drawing, for facilitating the understanding of the invention, as an equipment provided to the gaming machine 1010, only the game-use printed circuit board 1015, the R/W 1018 and the coin selector 1019 are shown. It is needless to say, however, that the gaming machine 1010 includes other peripheral equipment. The communication unit 1100 is constituted of a body 1101 and a receiving part 1110. The body 1101 includes a one-chip CPU having a memory (RAM) 1109 (hereinafter simply referred to as “CPU”) 1102, wherein a wireless communication circuit part 1103, a LAN controller part 1104 and an expansion I/F 1105, a serial I/F 106 and a general-purpose I/O 1107 are connected to the CPU 1102. Further, a body 1101 includes a power source circuit 1108.

The game-use control printed circuit board 1015 of the gaming machine 1010 is connected to the general-use I/O 1107 through the harness 1016. The R/W 1018 and the coin selector 1019 are connected to the game-use printed circuit board 1015. A notification signal is outputted to the game-use control printed circuit board 1015 from the R/W 1018 when the R/W 1018 performs the processing of reading money information from a prepaid card, deducting a predetermined amount from an amount which the money information indicates and writing money information indicative of an amount after deduction and, thereafter, is inputted to the general-purpose I/O 1107 through the harness 1016 from the game-use control printed circuit board 1015. A detection signal which is outputted to the game-use control printed circuit board 1015 from the coin selector 1019 when the coin selector 1019 detects a coin is inputted to the general-purpose I/O 1107 through the harness 1016 from the game-use control printed circuit board 1015. The notification signal or the detection signal inputted to the general-purpose I/O 1107 is inputted to the CPU 1102. Here, in this embodiment, although the explanation is made with respect to the case in which the communication units 1100 are connected with the game-use control printed circuit board 1015 of the gaming machine 1010, the communication unit 1100 may be connected with the coin selector 1019 and/or the R/W 1018. By constructing the communication unit 1100 in this manner, the communication unit 1100 can directly receive the signal (the detection signal or the notification signal) from the coin selector 1019 and/or the R/W 1018 without via the game-use control printed circuit board 1015

In a portion of a storage region of the memory 1109, the identification information which is respectively allocated to the gaming machine 1010 is stored. The identification information is not particularly limited and, for example, symbols which are constituted of the type and the number of the gaming machine 1010 or the line can be named as the identification information. The above-mentioned identification information is data which is transmitted from the mobile phone 1300 described later. The memory 1109 functions as the identification information storing means which stores the identification information received from the mobile phone 1300 by the set information receiving means (CPU 1102) described later.

Further, in a portion of the storage region of the memory 1109, the address information for allowing the communication unit 1100 to perform the communication with the server is stored. The address information is not particularly limited and the IP address or the like of the communication unit 1100 per se may be named as the address information. The above-mentioned address information is data transmitted from the mobile phone 1300 described later. The memory 1109 functions as the address information storing means which stores the address information received from the mobile phone 1300 using the set information receiving means (CPU1102) described later.

Further, in a portion of the storage region of the memory 1109, data such as serial numbers allocated to the respective communication units 1100 mounted in the respective gaming machines 1010, an identifier of the network (for example, ESSID or the like), information for ciphering communication data using a predetermined ciphering method (for example, WEP, WPA or the like) or the like are stored. These data are also data for allowing the communication between the communication units 1100 and the server 1200 and are data which are transmitted from the mobile phone 1300 using the set information receiving means (CPU 1102) described later.

Further, in a portion of the storage region of the memory 1109, as the sales information relevant to the sales amount of the gaming machine 1010, first sales information relevant to the sales amount attributed to the coins and second sale information relevant to the sales amount attributed to the value information are respectively stored. The sales information contains an amount of coins or value information used in the gaming machine 1010 and points of time at which the coins or the value information are used. Here, when an amount of the coins or the value information used in the gaming machine 1010 is a fixed amount (for example, when the amount is 100 yen for one game), as the sales information, only the points of time at which the coins or the value information are used may be stored. In this manner, the memory 1109 functions as sales information storing means which stores the sales information relevant to the sales amount in the gaming machine 1010 and is capable of respectively storing the first sales information relevant to the sales amount attributed to the coins and the second sales information relevant to the sales amount attributed to the value information.

Further, a ROM (not shown in the drawing) is incorporated in the CPU 1102 and a program for realizing the function of the communication unit 1100 is stored in the ROM. The CPU 1102 reads and executes the program so as to perform following processing (A) to (E).

(A) The CPU 1102 receives the identification information which a reallocated to the gaming machines 1010 respectively and the address information for performing the communication between the gaming machines 1010 and the server 200 from the mobile phone 1300. Here, the CPU 1102 functions as the set information receiving means.

(B) The CPU 1102 allows the memory 1109 (identification information storing means) to store the identification information received in the above-mentioned (A) and also allows the memory 1109 (address information storing means) to store the address information received in the above-mentioned (A).

(C) The CPU 1102 receives a signal which is outputted from the gaming machine 1010 when the coin which is inserted into the gaming machine 1010 is detected by the gaming machine 1010 or when the value information is read from the storage medium (for example, the prepaid card or the like) by the gaming machine 1010 by the general-purpose I/O 1107 through the harness 1016. In such an operation, the CPU 1102 receives the detection signal which is outputted from the gaming machine 1010 when the coin inputted to the gaming machine 1010 is detected by the gaming machine 1010 and the notification signal which is outputted from the gaming machine 1010 when the value information is read from the prepaid card by the gaming machine 1010 as signals which differ from each other. Here, the CPU 1102 functions as the receiving means.

(D) The CPU 1102 updates the sales information stored in the memory 1109 (sales information storing means) based on the signal received by the gaming machine 1010. In such an operation, the CPU 1102 functions as the sales information updating means. Here, the CPU 1102 updates the first sales information upon receiving the detection signal and updates the second sales information upon receiving the notification signal.

(E) The CPU 1102 transmits the sales information stored in the memory 1109 (sales information storing means) together with the identification information stored in the memory 1109 (identification information storing means) to the server 1200 through a wireless communication circuit part 1103 using an access point 1120 as a relay based on the address information stored in the memory 1109 (address information storing means). Here, the CPU 1102 functions as the sales information transmitting means.

The wireless communication circuit part 1103 enables the transmission/reception of data between the communication unit 1100 and the server 1200 by wireless. As the wireless communication circuit part 1103, a card type expansion device such as a PCMCIA type card, a MiniPCI type card, for example, can be adopted. Further, the LAN controller part 1104 enables the transmission/reception of data between the communication unit 1100 and the server 1200 by wire.

Various peripheral equipment can be connected to the expansion I/F 1105. A serial I/F 1106 is an interface for performing the serial transmission and can adopt a serial transmission method such as RS-232, RS-422 or the like.

A receiving part 1110 which is provided with infrared ray receiving elements (not shown in the drawing) is connected to the CPU 1102 of the body 1101. The receiving part 1110 is constituted to perform the infrared ray communication with the mobile phone 1300. Identification information and address information transmitted from the mobile phone 1300 are inputted to the CPU 1102 through the receiving part 1110 and are stored in the memory 1109. Here, the communication method of the infrared ray communication of the communication unit 1100 and the mobile phone 1300 is not particularly limited and, for example, conventionally known method such as IrDA or the like can be adopted.

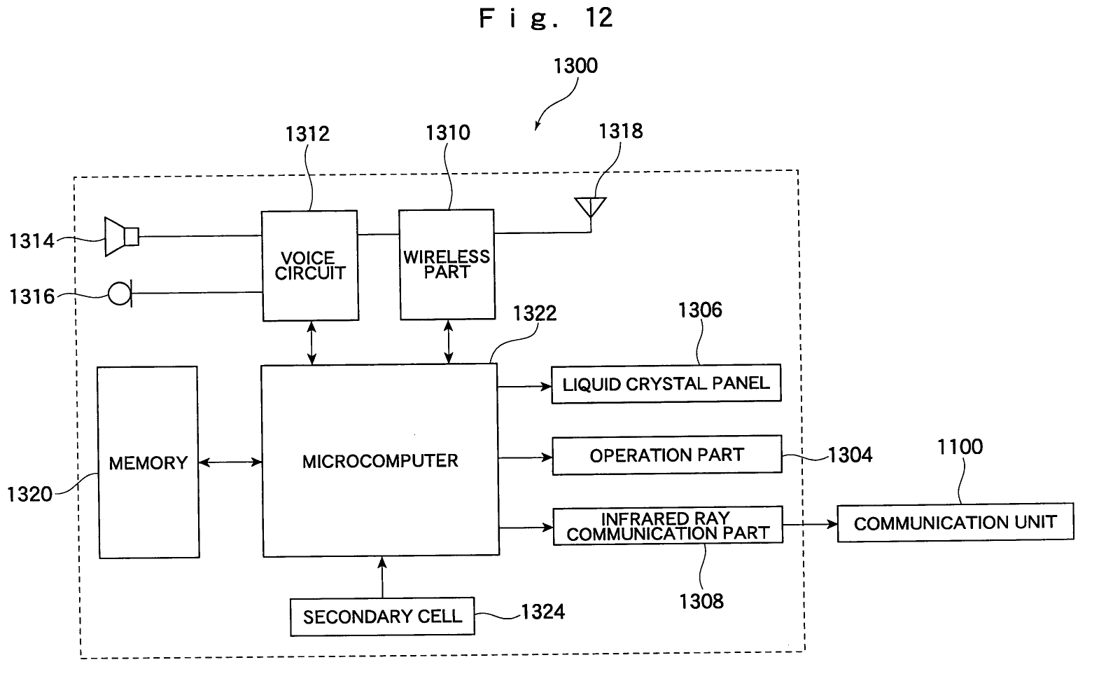

FIG. 12 is a block diagram showing an inner structure of the mobile phone 1300.

Here, the mobile phone 1300 corresponds to the portable terminal according to the present invention.

The mobile phone 1300 includes an operation part 1304 as an input means, a liquid crystal panel 1306 as a display means, an infrared ray communication part 1308 which is provided with infrared ray receiving elements (not shown in the drawing) and LED or the like (not shown in the drawing), a wireless part 1310, a voice circuit 1312, a speaker 1314, a microphone 1316, a transmission/reception antenna 1318, a non-volatile memory 1320, a microcomputer 1322 and a secondary cell 1324.

The wireless part 1310 is controlled by the microcomputer 1322 and performs transmission/reception with respect to a base station through a transmission/reception antenna 1318 using electric wave as medium. The voice circuit 1312 outputs the receiving signal outputted from the wireless part 1310 through the microcomputer 1322 to the speaker 1314 and, at the same time, outputs the voice signal outputted from the microphone 1316 as a transmitting signal to the wireless part 1310 through the microcomputer 1322.

The speaker 1314 converts the receiving signal outputted from the voice circuit 1312 into the receiving voice and outputs the receiving voice and the microphone 1316 converts the transmitting voice uttered by an operator into the voice signal and outputs the voice signal to the voice circuit 1312. The non-volatile memory 1320 stores various data and various programs in a non-volatile manner. The secondary cell 1324 supplies the power to the respective circuits. The microcomputer 1322 is constituted of a CPU, a ROM and a RAM and, for example, executes the dialing/ringing processing of the telephone, creation/transmission/reception processing of an electronic mail and the Internet processing and the like. Here, the transmission/reception of the electronic mail and the transmission/reception of data through the Internet are performed by the microcomputer 1322 through the wireless part 1310 and the transmission/reception antenna 1318.

The microcomputer 1322 downloads, based on a predetermined instruction which is inputted through the operation part 304 as the input means, applications for setting the identification information and the address information in the communication unit 1100 from the server 1200 through the Internet and stores the applications in the non-volatile memory 1320. This application includes a program relating to the present invention and various image data (for example, image data for inputting image or the like).

Then, the microcomputer 1322 functions as following (i) to (ii) by reading out the above-mentioned program from the non-volatile memory 1320 and by executing the program.

(i) The microcomputer 1322 displays an input image which enables the input of the identification information and the address information on the liquid crystal panel 1306 (display means) through the operation part 1304 (input means) based on image data for inputting image stored in the non-volatile memory 1320.

At this time, the microcomputer 1322 functions as the display control means.

(ii) The microcomputer 1322 transmits the identification information and the address information which are inputted through the operation part 1304 (input means) when the input image is displayed on the liquid crystal panel 1306 (display means) to the communication unit 1100 through the infrared ray communication part 1308.

At this time, the microcomputer 1322 functions as the set information transmission means.

In this embodiment, the case in which the mobile phone 1300 downloads the program with respect to the present invention from the server 1200 is explained. However, the program of the present invention may be preliminarily stored (preinstalled) in the storing means of the portable terminal.

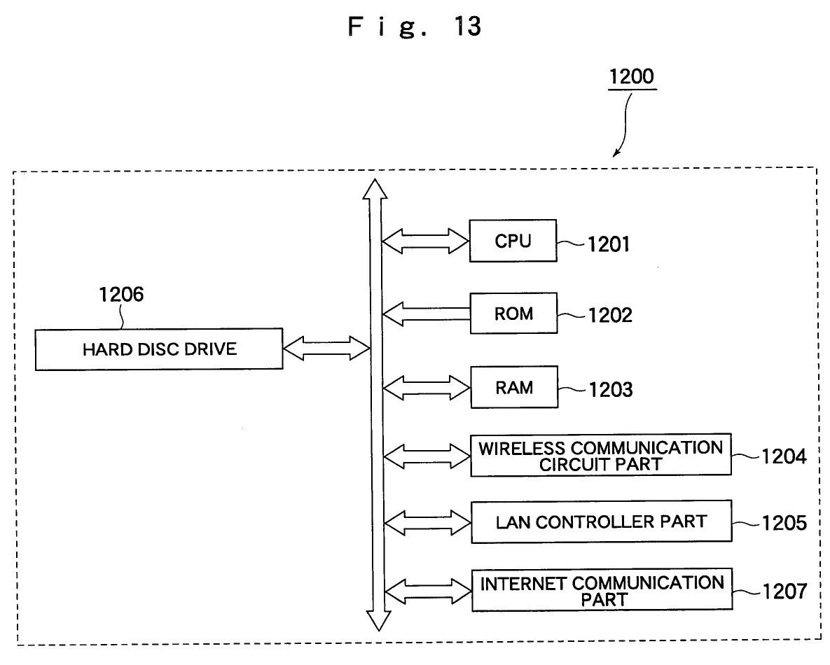

FIG. 13 is a block diagram showing the inner structure of the server 1200 which constitutes the store management system. The server 1200 includes a CPU 1201 as an arithmetic processing device, a ROM 1202, a RAM 1203, a wireless communication circuit part 1204, a LAN controller part 1205, a hard disc drive 1206 and an internet communication part 1207. The wireless communication circuit part 1204 receives, from the communication unit 1100 via the access point 1120, the sales information of the gaming machine 1010 and the identification information which is respectively allocated to the gaming machine 1010. The hard disc drive 1206 stores the sales information received from the communication unit 1100 for every identification information which is respectively allocated to each gaming machine 1010. The internet communication part 1207 enables the communication via the Internet and the CPU 1201 allows the Internet communication part 1207 to perform the communication with the mobile phone 1300 via the Internet.

Further, the hard disc drive 1206 stores applications including the program with respect to the present invention and various image data (for example, image data for inputting image and the like).

The CPU 1201 reads out the above-mentioned application from the hard disc drive 1206 and transmits the application to the mobile phone 1300 through the internet communication 1207 via the Internet at the time of receiving a signal indicating a request for downloading the application from the mobile phone 1300.

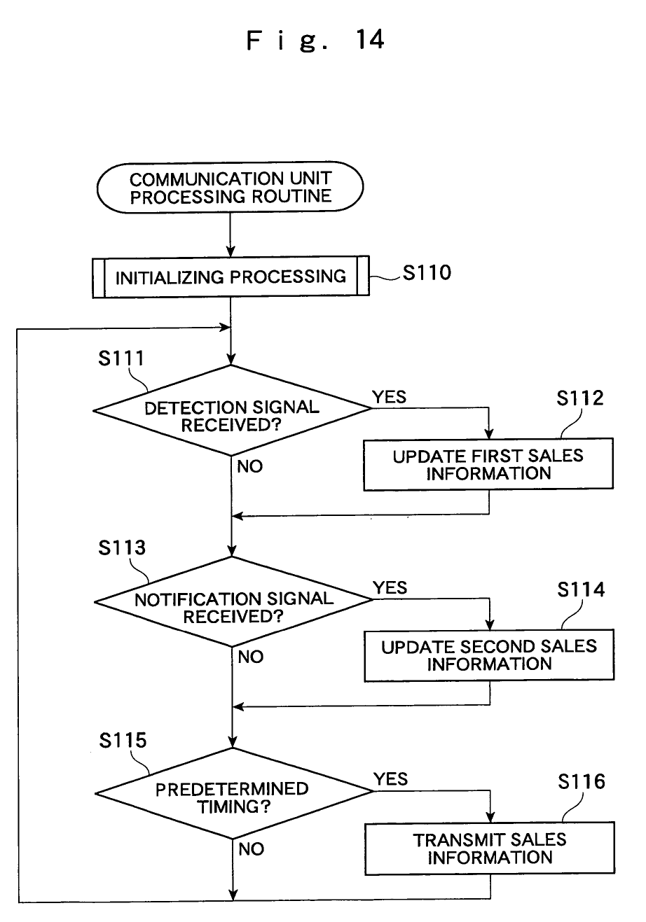

FIG. 14 is a flow chart showing a sub routine of a processing executed in the communication unit.

First of all, the CPU 1102 executes the initializing processing (step S110). Although the processing in the step S110 is described later, by executing this processing, the identification information and the address information are stored in a memory 1109, the time for recording the receiving time at which a detection signal or a notification signal is received from the gaming machine 1010 is set.

In this embodiment, the processing of the step S110 is executed before the communication unit 1100 is mounted in the inside of the gaming machine 1010. The processing of the step S110 is executed and the identification information and the address information are set by the mobile phone 1300 and, thereafter, the processing of step S111 to S116 which are described later are executed. It is needless to say that, in the present invention, the processing of the step S110 is executed in a state that the communication unit 1100 is mounted in the inside of the gaming machine 1010 and, thereafter, successively, the processing of the step S111 to S116 are executed.

Next, the CPU 1102 determines whether the CPU 1102 receives the detection signal from the gaming machine 1010 or not (step S111). The detection signal is a signal which is outputted from the coin selector 1019 through the game-use control printed circuit board 15 when the coin which is inserted into the coin inputting port 1011 of the gaming machine 1010 is detected by the coin selection 1019 and is inputted to the CPU 1102 through the harness 1016 from the general-purpose I/O 1107. When the CPU 1102 executes the processing in step S111, the CPU 1102 functions as the detection signal receiving means.

When it is determined that the detection signal is received in step S111, the CPU 1102 performs the processing to update the first sales information stored in the memory 1109 based on the detection signal (step S112).

Also in this embodiment, based on the sales information shown in FIG. 7 in the first embodiment, in step S112, the CPU 1102 allows the memory 1109 to store the point of times at which the detection signals are received as the first sales information. Here, the CPU 1102 also functions as the sales information updating means.

When it is determined that the detection signal is not received in step S111 or the processing in step S112 is executed, the CPU 1102 determines whether the CPU 1102 receives the notification signal from the gaming machine 10 or not (step S113). The notification signal is a signal which is outputted from the R/W 1018 through the game-use control printed circuit board 1015 when the R/W 1018 performs the processing of reading money information from a prepaid card inserted into the card insertion port 1012 of the gaming machine 1010, deducting a predetermined amount from an amount which the money information indicates and writing money information indicative of an amount after deduction to the prepaid card and is inputted to the CPU 1102 from the general-use I/O 1107 through the harness 1016. In executing the processing in step S113, the CPU 1102 functions as the notification signal receiving means.

When it is determined that the notification signal is received in step S113, the CPU 1102 performs the processing to update the second sales information stored in the memory 1109 in response to the notification signal (step S114). In this processing, the CPU 1102 stores the points of time at which the notification signals are received as the second sales information in the memory 1109(see FIG. 7). Here, the CPU 1102 functions as the sales information updating means.

When it is determined that the detection signal is not received in step S113 or when the processing in step S114 is executed, the CPU 1102 determines whether a predetermined timing arrives or not (step S115). Here, the predetermined timing is not particularly limited and may be, for example, a predetermined cycle (for example, every 10 minutes or every 1 hour or the like) or a predetermined condition (timing that the sales information is updated, timing that the sales amount which the sales information indicates reaches a predetermined amount, timing that the a request signal which requests the transmission of the sales information is received from the server).

In step S115, when it is determines that the predetermined timing arrives, the CPU 1102 transmits the sales information stored in the memory 1109 together with the identification information of the gaming machine 1010 stored in the memory to the server 1200 through the access point 1120 from the wireless communication circuit part 1103 based on the address information stored in the memory 1109 (step S116). Here, the CPU 1102 functions as the sales information transmitting means which transmits the sales information stored in the memory 1109 (sales information storing means) to the server 1200 together with the memory 1109 (identification information storing means) to the server 1200 through the communication line based on the address information stored in the memory 1109 (identification information storing means). Thereafter, the processing returns to step S111 and the processing in step S111 to S116 is repeatedly executed. Here, the sales information which is transmitted to the server among the sales information stored in the memory 1109 may be readily deleted from the memory 1109, may be deleted at the predetermined timing, or may be deleted when an instruction indicative of the deletion of the data is inputted from the outside (for example, a mobile phone, the server or the like).

In the communication units 1100 of respective gaming machines 1010 installed in the store, the processing shown in FIG. 7 in the first embodiment is executed, wherein when the sales information is transmitted to the server 1200, in the server 1200 the sales information is managed in the same manner as the management shown in FIG. 8 in the first embodiment.

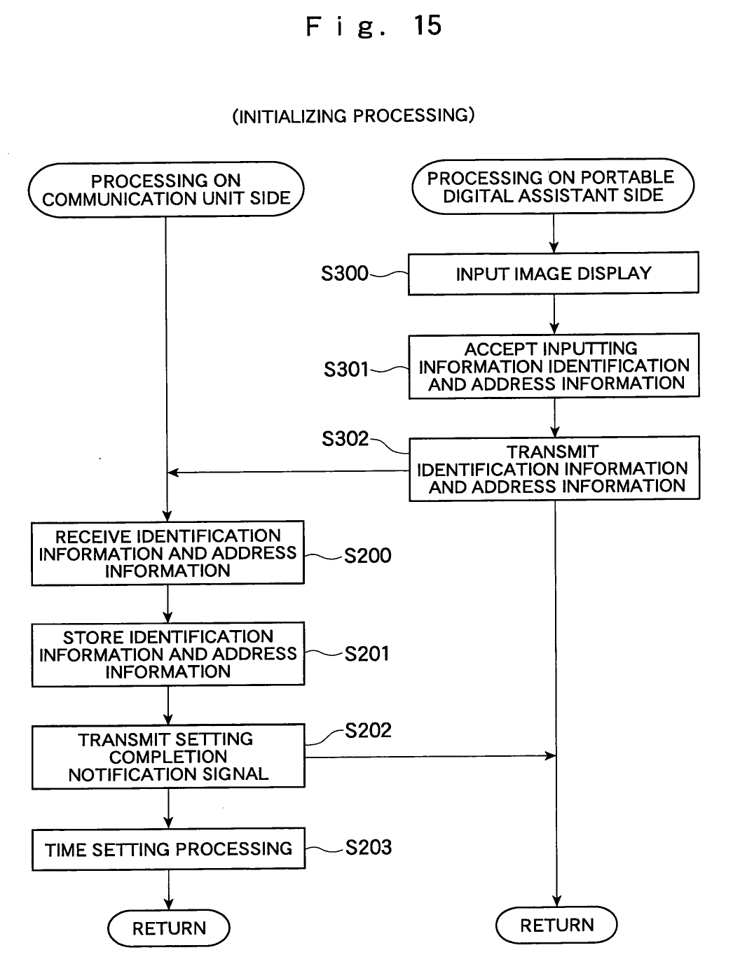

FIG. 15 is a flow chart showing an initial setting processing which is executed in the communication unit 1100 and the mobile phone 1300. The processing is executed in step S110 in the processing shown in FIG. 15.

First of all, the microcomputer 1322 of the mobile phone 1300 reads out image data for inputting images from the non-volatile memory 1320 and, based on the image data, executes the processing which displays the input image on the liquid crystal panel 1306 (step S300).

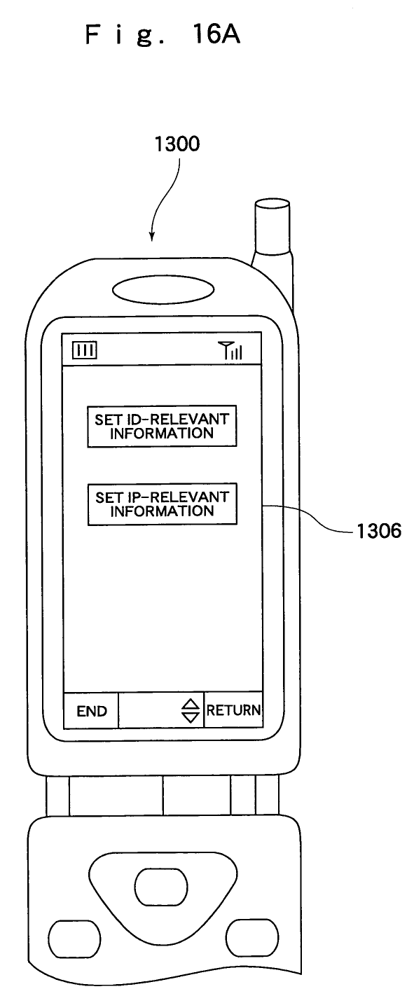

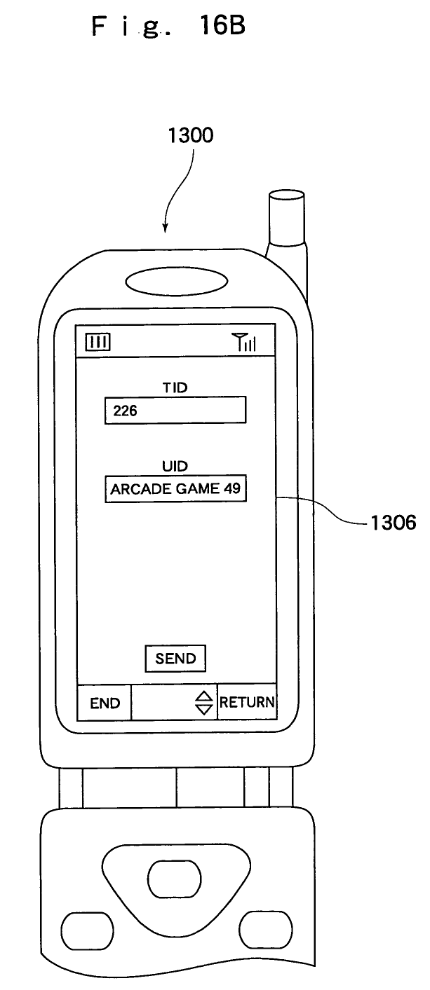

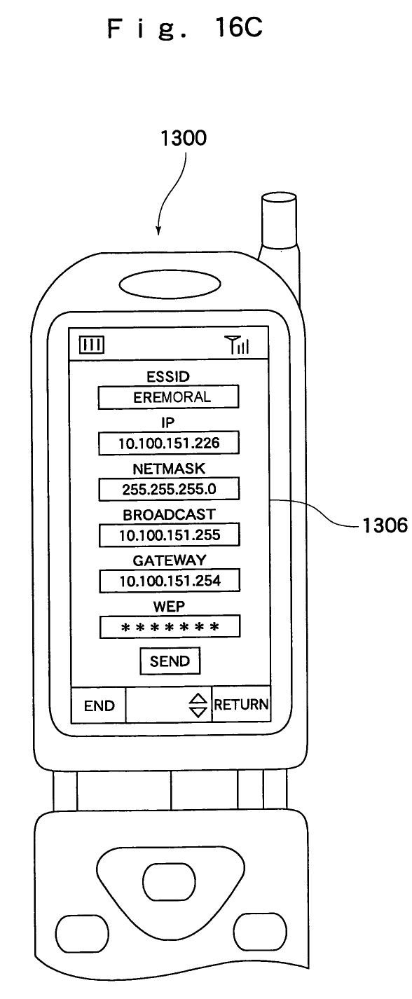

As a result of the processing of the step S300, the images shown in FIG. 16A to FIG. 16C are displayed on the liquid crystal panel 1306 of the mobile phone 1300.

FIG. 16A is input images which are displayed on the liquid crystal panel 1306 initially at the time of executing the processing of step S300.

On the center upper side of the liquid crystal panel 1306, an image indicating the choice of “setting of ID relevant data” and an image indicating the choice of “setting of IP relevant data” are displayed.

When the input images shown in FIG. 16A are displayed, by inputting the instruction to select either “setting of ID relevant data” or “setting of IP relevant data” through the operation part 1304, the input images shown in FIG. 16B or FIG. 16C are displayed.

FIG. 16B shows input images which are displayed on the liquid crystal panel 1306 when the instruction to select the image indicating the choice of “setting of ID relevant data” through the operation part 1304 is imputed when the input images shown in FIG. 16A are displayed.

In the center upper side of the liquid crystal panel 1306, an image indicating an entry “TID” and an image indicating an entry “UID” are displayed and images showing input columns below the images indicating respective entries are displayed. “UID” is constituted of the name and the number of the gaming machine 1010 in the inside of the store and corresponds to the identification information according to the identification according to the present invention. “TID” shows a serial number which is allocated to each communication unit 1100 mounted in the store.

When the input images shown in FIG. 16B are displayed, by inputting predetermined letters and/or numbers in the respective input columns and inputting the instruction and by selecting the choice of “SEND” which is positioned in the center lower portion of the liquid crystal panel 1306 through the operation part 1304, various data including the identification information can be transmitted to the communication unit 1100.

FIG. 16C is inputting images which are displayed on the liquid crystal panel 1306 in the case that the instruction to select the image indicating the choice of “determination of IP relevant data” is inputted through the operation part 1304 when the input images shown in FIG. 16A are displayed.

On the liquid crystal panel 1306, images indicating the respective entries are displayed in the order of “ESSID”, “IP”, “NETMASK”, “BROADCAST”, “GATEWAY”, “WEP” from the above. Images showing respective input columns are displayed under the images showing the respective entries. “ESSID” is a network identifier. “IP” is an IP address of the communication unit 1100 and used at the time when the communication unit 1100 performs the communication with the server 1200. This IP address corresponds to the address information for performing the communication with the server 1200. “NETMASK”, “BROADCAST”, “GATEWAY” are used respectively at the time when the communication with the server 1200 is performed. A predetermined password is inputted to the “WEP”. When the input images shown in FIG. 16C are displayed, by inputting predetermined letters and/or numbers in the respective input columns and inputting the instruction to select the choice of “SEND” which is positioned in the center lower portion of the liquid crystal panel 1306 through the operation part 1304, various data including the identification information can be transmitted to the communication unit 1100.

When the processing of the above-mentioned step S300 is executed, the microcomputer 1322 functions as the display control means. Next, the microcomputer 1322 receives the inputting of the identification information and address information through the operation part 1304 as the input means (step S301). Then, the microcomputer 1322 transmits the identification information and the address information which are inputted in the step S301 to the communication unit 1100 through the infrared ray communication through the infrared ray communication part 1308 (step S302). At this time, the microcomputer 1322 functions as the set information transmitting means which transmits the identification information and the address information inputted through the operation part 1304 (input means) when the input images (see FIG. 16A to FIG. 16C) on the liquid crystal panel 1306 to the communication unit 1100.

Here, in this embodiment, after the processing of the step S301 is executed, the following processing may be executed. That is, before the identification information and the address information inputted in the step S301 are transmitted to the communication unit 1100, the identification information and the address information are once transmitted to the server 1200. The server 1200 determines whether the identification information and the address information received from the mobile phone 1300 are overlapped with the identification information and the address information which are set in other communication unit 1100 or not and transmits the determination result to the mobile phone 1300. When the determination result indicating that the identification information and the address information inputted from the mobile phone 1300 are not overlapped with the identification information and the address information set in the other communication unit is received, the microcomputer 1322 of the mobile phone 1300 executes the processing of the step S302 to transmit the identification information and the address information to the communication unit 1100. On the other hand, when the determination result indicating that the identification information and the address information inputted from the mobile phone 1300 are overlapped with the identification information and the address information set in the other communication unit is received, the processing of the step S302 may not be executed. With such a constitution, it can obviate that wrong identification information and address information are set in the communication unit 1100.

When the identification information and the address information are transmitted from the mobile phone 1300, the CPU 1102 of the communication unit 1100 receives the identification information and the address information through the receiving part 1110 (step S200). At this time, the CPU 1102 functions as the set information receiving means.

Next, the CPU 1102 allows the identification information and the address information received in the step S200 to be stored in one part of the storing region of the memory 1109 respectively (step S201). Thereafter, the CPU 1102 transmits a setting completion notification signal showing that the setting of the identification information and the address information in the communication unit 1100 is completed to the mobile phone 1300 (step S202).

Subsequently, the CPU 1102 performs the communication with the server 1200 based on the address information stored in the memory 1109 and acquires the data corresponding to the present time from the server 1200 and, thereafter, performs the processing to set the time (step S203). Here, the processing to set the time is a processing to set the time for recording the receiving time at which a detection signal or a notification signal is received from the gaming machine 1010.

In this embodiment, the case in which the communication unit 1100 acquires the data corresponding to the present time from the server 1200 and sets the time. However, the present invention is not limited to this constitution and, for example, the time may be set in the communication unit 1100 by allowing the mobile phone 1300 to transmit the data with respect to the present time.

As described hereinabove, according to the communication unit 1100, it is possible to store the identification information and the address information transmitted from the mobile phone 1300, by inputting the identification information and the address information to the mobile phone 1300 and by transmitting the identification information and the address information from the mobile phone 1300, the identification information and the address information can be set in the communication unit 1100. Accordingly, it is not necessary to provide a plurality of buttons, displays or the like which are necessary at the time of inputting the identification information and the address information to the communication unit 1100 and hence, the cost can be reduced.

Further, by using the communication unit 1100, the gaming machine 1010 and the server 1200 can be connected through the communication line and hence, following constitution can be realized. That is, the sales information with respect to the sales amount information is stored by receiving a detection signal or a notification signal from the gaming machine 1010 and the sales amount is transmitted to the server at a predetermined timing and hence, by mounting the communication unit 1100 on each gaming machine 1010, the store management system which enables to grasp the sales amount in real time can be constructed (see FIG. 10).

Further, since the communication unit 1100 constitutes a body separated from the gaming machine 1010, the communication units 1100 can be respectively mounted on the gaming machines 1010 which are manufactured by different game makers and hence, it is possible to construct a store management system which can grasp the sales amount in the store provided with a plurality of gaming machines 1010 manufactured by different game makers in real time.

Further, since the communication unit 1100 constitutes a body separated from the gaming machine 1010, the store side can arbitrarily select whether to construct store management system or not based on the store size or the like.

Further, by mounting the communication unit 1100 on the existing gaming machine 1010, it is possible to construct the store management system. Accordingly, the cost of constructing the system can be reduced.

Further, in the case that a gaming machine 1010 is removed from the store and a new gaming machine 1010 is installed, the communication unit 1100 may be dismounted from the gaming machine to be removed and be mounted on the newly-installed gaming machine 1010 thus also reducing the cost of system management.

In the communication units of this embodiment, as in the communication unit 1100 according to this embodiment, it is favorable that the first sales information relevant to the sales amount attributed to coins and the second sales information relevant to the sale amount attributed to value information are separately stored, updated and transmitted to the server 1200.

That is, the sales information storing means (for example, the memory 1109) can store the first sales information relevant to the sales amount attributed to coins and the second sales information relevant to the sale amount attributed to value information separately and it is favorable that the receiving means (for example, the CPU 1102) is provided with the means to receive a detection signal outputted from the gaming machine when the gaming machine detects a coin which is inserted into the gaming machine and the means to receive a notification signal outputted from the gaming machine when the gaming machine reads out the value information from a predetermined storing medium and, the sales information updating means (for example, the CPU 1102) updates the first sales information stored in the sales information storing means in response to the detection signal received by the detection signal receiving means and updates the second sales information stored in the above-mentioned identification information storing means in response to the notification signal received by the notification signal receiving means.

This is because that, since the sales amount by coins and the sales amount by value information can be grasped separately (see FIG. 9B of the first embodiment), for example, by configuring that the coins are taken out when the sales amount by coins reaches a predetermined amount, the store management can be performed more smoothly.

By using the mobile phone 1300 according to the present invention, by inputting the identification information and the address information when the input images are displayed and by transmitting the identification information and the address information to the communication unit 1100 (see FIG. 15, FIG. 16A to FIG. 16C), the identification information and the address information can be set in the communication unit 1100. Accordingly, it is not necessary to directly operate the communication unit 1100 mounted on each gaming machine 1010 thus reducing troubles of constructing the system.

Further, by using the program with respect to the present invention, by inputting the identification information and the address information to the mobile phone 1300 and by transmitting the identification information and the address information to the communication unit 1100, the identification information and the address information can be set in the communication unit 1100. Accordingly, it is not necessary to directly operate the communication unit 1100 mounted on each gaming machine 1010 thus reducing troubles of constructing the system.

As has been explained, according to second embodiment of the invention, it is possible to store the identification information and the address information transmitted from the portable terminal (for example, mobile phone or the like) and hence, it is possible to set the identification information and the address information in the communication unit by inputting the identification information and the address information in the portable terminal and thereafter transmitting the identification information and the address information from the portable terminal. Accordingly, it is unnecessary to provide a plurality of button switches, a display and the like which become necessary at the time of inputting the identification information and the address information thus leading to the reduction of cost.

Further, by allowing the communication unit and the portable terminal to be communicated with each other by wireless in a state that the communication unit is mounted in the inside of the gaming machine, it is unnecessary for the store manager to stand on a site thus reducing time and efforts necessary for constructing the system. That is, when the communication unit is mounted in the inside of the gaming machine, it is necessary to set the information for communication after opening the door or the like which the gaming machines possess, there exists the possibility that an illegal action (for example, applying tricks to the gaming machine, picking of the money from the gaming machine or the like) is conducted. To prevent such an illegal action, in setting the identification information and the address information, it is necessary for the store manager to stand on the site and hence, the time and efforts for constructing the system are increased. As described above, by allowing the setting of the communication unit by wireless inside and outside the gaming machine after mounting the communication unit in the inside of the gaming machine, it is possible to overcome such a drawback.

As the above-mentioned wireless communication, it is desirable to adopt a wireless method in which an exterior wall of the casing of the gaming machine does not constitute a barrier than the communication such as the infrared ray communication which mounts a sensor which detects infrared rays in a state that the sensor faces outside from the gaming machine. When the infrared ray communication is adopted, it is necessary to mount the sensor which detects the infrared rays on the exterior of the gaming machine and hence, the hole forming becomes necessary on the site whereby not only tools and technique necessary for the mounting operation are required, but also, for example, operations such as the recycling of the gaming machine, the transfer of the gaming machine per se, and the rearrangement of the communication unit in other gaming machine become cumbersome. It is needless to say that the present invention is not limited to the above-mentioned constitution. In the above-mentioned embodiment, as mentioned previously, before mounting the communication unit in the inside of the gaming machine, the identification information and the address information are preliminarily set in the communication unit from the portable terminal using the infrared ray communication (for example, IrDA or the like).

Further, according to the second embodiment of the present invention, with the use of the communication unit which allows the gaming machine and the server to be connected with each other through the communication line, the sales information relevant to the sales amount of the gaming machine is stored, and the sales information is transmitted to the server from the communication unit, whereby it is possible to construct the store management system which is capable of grasping the sales amount in real time by mounting the communication units in respective gaming machines.

Further, since the communication unit is provided separately from the gaming machine, it is possible to install the communication unit in the respective gaming machines which are manufactured by the different game makers. In the store where a plurality of gaming machines which are manufactured by different game makers are installed, it is possible to reduce the time and efforts for constructing the system which can grasp the sales amount in real time thus leading to the reduction of cost for constructing the system. Still further, since the communication unit is provided separately from the gaming machine, the store side can arbitrarily select the construction or the non-construction of the store management system depending on the size of the store.

Further, it is possible to construct the store management system by installing the communication units in the existing gaming machines and hence, the cost for constructing the system can be reduced. Still further, in introducing new gaming machines by dismantling the gaming machines from the store, it is possible to remove the communication units from the dismantled gaming machines and to mount the communication unit on the newly introduced gaming machines and hence, the cost for running the system can be reduced.

By transmitting the identification information and the address information to the communication unit by inputting the identification information and the address information in the portable terminal, it is possible to set the identification information and the address information in the communication unit. Accordingly, it is unnecessary to directly manipulate the communication unit which is mounted in each gaming machine and hence, the time and efforts necessary for constructing the system can be reduced.

Further, it is possible to set the identification information and the address information in the communication unit by inputting the identification information and the address information in the portable terminal and by transmitting the identification information and the address information to the communication unit, it is unnecessary to directly manipulate the communication units which are installed in the respective gaming machines whereby time and efforts for constructing the system can be reduced.

According to the communication unit of the second embodiment, in the store where a plurality of gaming machines which are manufactured by different game makers are installed, it is possible to reduce the time and efforts for constructing the system which can grasp the sales amount in real time thus leading to the reduction of cost for constructing the system. According to the portable terminal of the present invention, it is possible to set the identification information and the address information without directly manipulating the communication unit mounted in each gaming machine thus reducing the time and efforts for constructing the system. According to the sales management method of the present invention, it is possible to set the identification information and the address information using the portable terminal without directly manipulating the communication unit mounted in each gaming machine thus reducing the time and efforts for constructing the system.

The present invention has been explained by referring to the first embodiment and the second embodiment hereinabove. However, only the specific example is described and the present invention is not particularly limited to the above-mentioned constitution and the designs of specific constitutions such as respective means or the like can be modified arbitrarily. Further, with respect to the advantageous effects described in the embodiments of the present invention, only the most favorable advantageous effects produced by the present invention are listed and, the advantageous effects according to the present invention are not limited to the advantageous effects described in the embodiments of the present invention.

What is claimed is:

1. A communication unit which is connectable with gaming machines and a server which manages a store in which the gaming machines are installed through a communication line, the communication unit comprising:
an identification information storing part which stores identification information respectively allocated to the gaming machines;
a sales information storing part which stores sales information on sales amounts of the gaming machines;
a receiving part which receives a signal outputted from the gaming machine when one of at least two different value gaming mediums is detected or read by the gaming machine;
a sales information updating part which updates the sales information stored in the sales information storing part in response to the signal received by the receiving part; and
sales information transmitting part which transmits the sales information stored in the sales information storing part together with the identification information stored in the identification information storing part through the communication line.

2. A communication unit according to claim 1, wherein the value gaming mediums include coins which are inserted into the gaming machine and value information which is stored in a predetermined storage medium, and the receiving part receives a signal outputted from the gaming machine when the coin is inserted into the gaming machine or when the value information is read by the gaming machine through the communication line.

3. A communication unit according to claim 1, wherein the sales information storing means is capable of storing first sales information relevant to the sales amounts attributed to coins and second sales information relevant to sales amounts attributed to value information respectively,
the receiving part includes a detection signal receiving part which receives a detection signal which is outputted from the gaming machine when the coin which is inserted in the gaming machine is detected by the gaming machine, and a notification signal receiving part which receives a notification signal outputted from the gaming machine when the value information is read from a predetermined storing medium by the gaming machine, and
the sales information updating part updates the first sales information stored in the sales information storing part based on the detection signal received by the detection signal receiving part and the second sales information stored in the identification information storing part based on the notification signal received by the notification signal receiving part.

4. A communication unit according to claim 1, further comprising:
a set information receiving part which receives the identification information allocated to the respective gaming machines and address information provided for allowing the communication with the server from a portable terminal; and
an address information storing part which stores the address information received by the set information receiving part, wherein
the identification information storing part stores the identification information received by the predetermined set information receiving part.

5. A communication unit according to claim 4, the sales information transmitting part transmits the sales information stored in the sales information storing part together with the identification information stored in the identification information storing part to the server through the communication line based on the address information stored in the address information storing part.

6. A sales management method of gaming machines using a communication unit which is connectable with the gaming machines and a server which manages a store in which the gaming machines are installed through the communication line, the sales management method comprising the steps of:
storing identification information respectively allocated to the gaming machines;
storing sales information on sales amounts of the gaming machines;
receiving a signal outputted from the gaming machine when one of at least two different value gaming mediums is detected or read by the gaming machine;
updating the sales information in response to the signal received by the receiving means; and
transmitting the sales information stored in the sales information storing unit together with the identification information through the communication line.

7. A sales management method of gaming machines using a communication unit which is connectable with the gaming machines and a server which manages a store in which the gaming machines are installed through a communication line, the sales management method comprising the steps of:
receiving identification information which are respectively allocated to the gaming machines and address information which are provided for allowing the communication unit to perform the communication with the server from a portable terminal;
storing the identification information; and
storing the address information.

8. A portable terminal capable of performing the transmission/reception of data with a communication unit and including an inputting part, a storing part and a display part, the portable terminal comprising:
a display control part which allows the display part to display an inputted image which allows the inputting of the identification information and the address information through the inputting part based on image data for inputted image stored in the storing part; and
a set information transmitting part which transmits the identification information and the address information which are inputted through the inputting part when the inputted image is displayed on the display part through the communication unit, wherein
the communication unit which is connectable with gaming machines and a server which manages a store in which the gaming machines are installed through a communication line comprises:
an identification information storing part which stores identification information respectively allocated to the gaming machines;
a sales information storing part which stores sales information on sales amounts of the gaming machines;
a receiving part which receives a signal outputted from the gaming machine when one of at least two different value gaming mediums is detected or read by the gaming machine;
a sales information updating part which updates the sales information stored in the sales information storing part in response to the signal received by the receiving part; and
a sales information transmitting part which transmits the sales information stored in the sales information storing part together with the identification information stored in the identification information storing part through the communication line.
